(19) United States
(12) Patent Application Publication
(10) Pub. No.: US 2022/0321670 A1
(43) Pub. Date: Oct. 6, 2022

(54) INFORMATION PROCESSING APPARATUS AND INFORMATION PROCESSING METHOD

(71) Applicant: SHARP KABUSHIKI KAISHA, Sakai City (JP)

(72) Inventor: Naoki Kodama, Sakai City (JP)

(21) Appl. No.: 17/702,986

(22) Filed: Mar. 24, 2022

(30) Foreign Application Priority Data
Apr. 2, 2021 (JP) 2021-063326

(51) Int. Cl. H04L 67/55; H04N 1/32

(52) U.S. Cl. CPC H04L 67/26; H04N 1/32438; H04N 2201/0017; H04N 2201/3218

(57) ABSTRACT

An information processing apparatus includes an event notification receiver that receives the same event notification as for a user terminal, a read information receiver that receives read information indicating that the user terminal has confirmed the event notification, and an event processor that executes different processing regarding the event notification on the basis of whether or not the read information was received by the read information receiver.

### BACKGROUND OF THE INVENTION

### Field of the Invention

The present invention relates to an information processing apparatus and an information processing method, and in particular, for example, to an information processing apparatus, an information processing program, and an information processing method which deliver events to both a multifunction machine and a user terminal.

### Description of the Background Art

Japanese Patent Application Publication No. 2013-206184 discloses a notification linkage device that provides the same notification to the same user in different systems, and when the notification is read in one of the two systems, information thereof is linked to the other system.

In the notification linkage device disclosed in Japanese Patent Application Publication No. 2013-206184, though whether the same notification has been read or not by the same user in the different systems can be managed, depending on a type of the notification, there may a case where, even if the notification content has been read in one of the systems, the notification content should be confirmed and processed in the other system, and thus, further improvement of user convenience is desired.

Therefore, a main object of the present invention is to provide a novel information processing apparatus and information processing method.

Another object of the present invention is to provide an information processing apparatus and an information processing method that can improve user convenience in cases where an event is distributed to both a multifunction machine and a user terminal.

### SUMMARY OF THE INVENTION

In order to solve the above problem, the present invention has adopted the following structure. Reference signs and supplementary explanations in parentheses and the like indicate correspondence with embodiments described to help understanding of the present invention and do not limit the present invention in any way.

A first invention is an information processing apparatus including an event notification receiver that receives the same event notification as for a user terminal, a read information receiver that receives read information indicating that the user terminal has confirmed the event notification, and an event processor that executes different processing regarding the event notification on the basis of whether or not the read information was received by the read information receiver.

In the first invention, the information processing apparatus (20: a reference sign indicating a corresponding part in an embodiment. The same applies hereinafter.) receives delivery of the same event notification as for the user terminal (40) as a personal device. When the information processing apparatus receives the delivery of the event notification, the event notification receiver (212, S25, S27) receives the event notification. The read information receiver (212, S29, S31) receives read information indicating that the user terminal has confirmed the event notification. The event processor (212, S37 to S43) executes different processing regarding the event notification on the basis of whether or not the read information has been received by the read information receiver.

According to the first invention, different processing is executed for the event notification on the basis of whether or not the read information has been received and thus, user convenience can be improved when events are delivered to both user terminals (personal devices).

A second invention is dependent on the first invention and is an information processing apparatus that further includes a display unit, and the event processor executes different processing in the display unit of the event notification.

A third invention is dependent on the second invention and is an information processing apparatus in which the event notification includes a first event notification and a second event notification of a type different from that of the first event notification, and in a case where the event notification received by the event notification receiver is the first event notification, the event processor does not display the first event notification on the display unit when the read information receiver receives the read information.

A fourth invention is dependent on the third invention and is an information processing apparatus in which, in a case where the event notification received by the event notification receiver is the second event notification, even if the read information receiver has received the read information, the event processor displays the second event notification on the display unit.

A fifth invention is an information processing method in an information processing apparatus and is an information processing method which includes an event notification receiving step to receive the same event notification as for the user terminal, a read information receiving step to receive read information indicating that the user terminal has confirmed the event notification, and an event processing step to execute different processing regarding the event notification on the basis of whether or not the read information has been received in the read information receiving step.

According to the present invention, since different processing (or display processing) is executed for the event notification on the basis of whether it has been read or unread at the user terminal (personal device), user convenience can be improved even when event notification is delivered to both the information processing apparatus and the user terminal.

The aforementioned objects and other objects, features, and advantages of the present invention will be more apparent from the detailed description of the embodiments given below with reference to figures.

### BRIEF DESCRIPTION OF THE DRAWINGS

FIG. 1 is a block diagram showing an entire configuration of an information processing apparatus of an embodiment (first embodiment) of the present invention.

FIG. 2 is a block diagram showing an electrical configuration of a multifunction machine in the first embodiment.

FIG. 3 is a block diagram showing a configuration of a server in the first embodiment.

FIG. 4 is a block diagram showing the electrical configuration of a user terminal in the first embodiment.

FIG. 5 is a memory map showing a configuration in a main storage of the multifunction machine in the first embodiment.

FIG. 6 is a memory map showing a configuration in a main storage of the server in the first embodiment.

FIG. 7 is a memory map showing a configuration of a main storage of the user terminal in the first embodiment.

FIG. 8 is a flowchart showing an operation of event processing executed by a main controller of the server in the first embodiment.

FIG. 9 is a flowchart showing the operation of the event processing executed by a main controller of the multifunction machine in the first embodiment.

FIG. 10 is a flowchart showing the operation of the event processing executed by the main controller of the user terminal in the first embodiment.

FIG. 11A and FIG. 11B are illustrations showing an event display example of the multifunction machine and the user terminal of Type 1 in the first embodiment.

FIG. 12A and FIG. 12B are illustrations showing an event display example of the multifunction machine and the user terminal of Type 2 in the first embodiment.

FIG. 13A and FIG. 13B are illustrations showing another example of the event display of the multifunction machine and the user terminal of Type 2 in the first embodiment.

FIG. 14A and FIG. 14B are illustrations showing another example of the event display of the multifunction machine and the user terminal of Type 2 in the first, embodiment.

### DESCRIPTION OF THE PREFERRED EMBODIMENTS

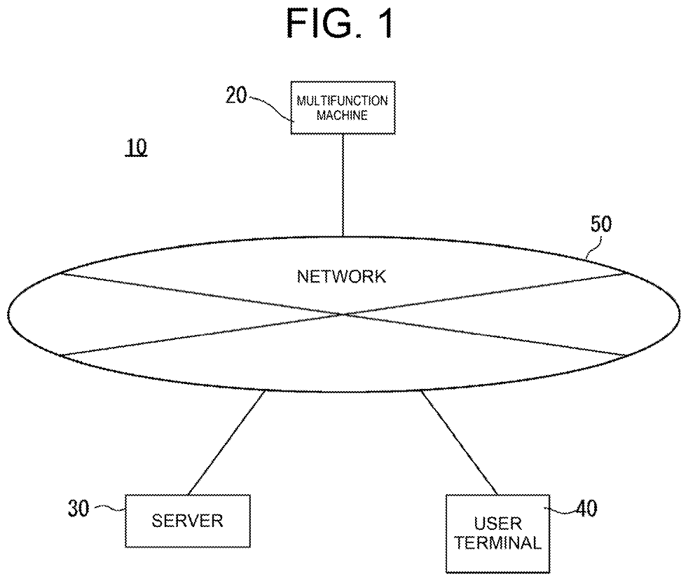

Referring to FIG. 1, an information processing system 10 of an embodiment (first embodiment) of the present invention includes a multifunction machine 20, a server 30, and a user terminal 40, and the multifunction machine 20, the server 30, and the user terminal 40 can communicate signals, data, or information with each other via a network 50 such as the Internet.

The multifunction machine 20 in this embodiment is an example of an information processing apparatus and includes a plurality of functions such as copying, printing, scanning, and facsimile functions. The server 30, for example, delivers events that occurred in the multifunction machine 20 to the multifunction machine 20 and the user terminal 40 in response to a delivery request from the multifunction machine 20. The user terminal 40 is a personal device of a user, who is an owner, and may be a smartphone, a tablet computer, or a personal computer, as an example. The network 50 is, for example, the Internet as described above, but not limited to that, and it may also be a VPN (Virtual Private Network) or an exclusive line.

In FIG. 1, only one unit of the user terminal 40 is connected to the network 50, but the user terminals 40 in the number corresponding to the number of users related to this information processing system 10 may be connected to the network 50.

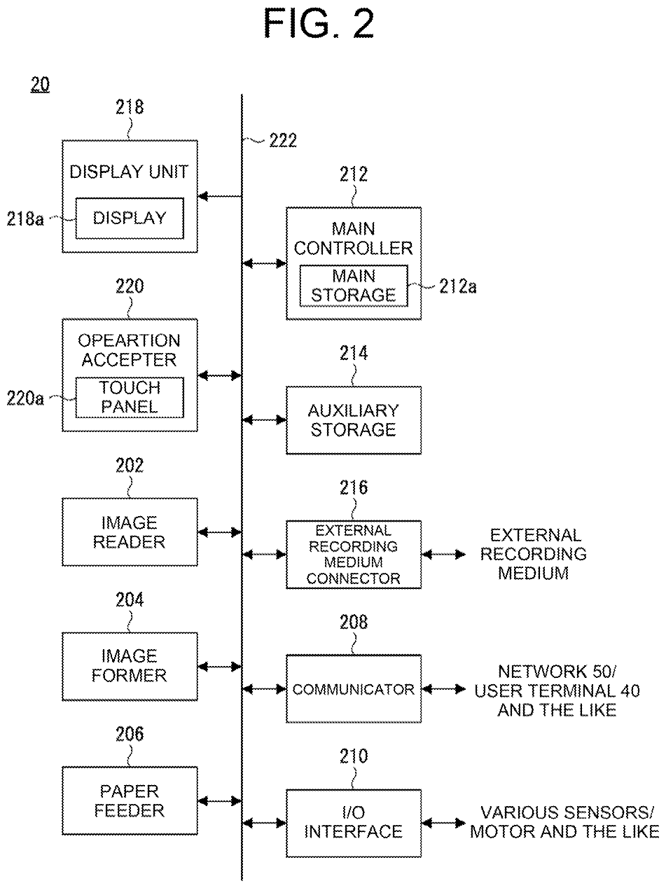

As shown in FIG. 2, the multifunction machine 20 in the first embodiment includes an image reader 202, an image former 204, and a paper feeder 206. The multifunction machine 20 also includes a communicator 208 and an input/output interface WO 210. Moreover, the multifunction machine 20 includes a main controller 212, an auxiliary storage 214, and an external storage medium connector 216. Furthermore, the multifunction machine 20 includes a display unit 218 and an operation acceptor 220. These are connected to each other via a common bus 222.

As is well known, the image reader 202 is an image reader that reads an image of a document and outputs two-dimensional image data corresponding to the image of the document. For this purpose, the image reader 202 includes a document loading table, a light source, a plurality of mirrors, an imaging lens, a line sensor and the like, all of which are not shown.

The image former 204 is an image former that forms images on recording sheets using an electrophotographic method. For this purpose, the image former 204 includes a photosensitive drum, a charging device, an exposure device, a developing device, a transfer device, a fixing device and the like, all of which are not shown. The image data to be used for image forming processing by this image former 204 is image data output from the image reader 202, for example. In addition, the image data based on various files taken in from the user terminal 40 and the external storage medium which will be described later may also be used for image forming processing by the image former 204. The image former 204 can execute not only black and white image forming processing, but also color image forming processing.

The paper feeder 206 includes a paper feed cassette (not shown) and is a paper feeder that feeds recording sheets stored in this paper feed cassette one by one into the image former 204.

The communicator 208 is a communicator that can perform bi-directional communication processing via the network 50. Moreover, the communicator 208 can also conduct communication using wireless methods such as the Wi-Fi (registered trademark) method. This communication processing using the wireless method is executed, for example, with the user terminal 40 located near the multifunction machine 20.

The input/output interface 210 is connected to the various sensors and motors or strictly speaking, it is connected to drive circuits thereof. The various sensors include a sensor for detecting presence or absence of a sheet in the paper feed cassette, a toner sensor in the developing device, and a paper detection sensor provided as appropriate in a paper transport path from the paper feed cassette to a paper discharger. The motor includes a motor for paper transport, which is provided as appropriate in the paper transport path, and a motor for driving the photosensitive drum as described above. Through this input/output interface 210, output signals from the respective sensors are sent to the main controller 212, and control signals are sent from the main controller 212 to the respective motors.

The main controller 212 is a controller, which takes charge of overall control of the multifunction machine 20. Thus, the main controller 212 includes a computer with a CPU. Also, the main controller 212 includes a main storage 212a serving as a main storage that can be directly accessed by the CPU. This main storage 212a includes a RAM and a ROM, for example.

The auxiliary storage 214 is an auxiliary storage including, for example, a hard disk and a flash memory. This auxiliary storage 214 stores various types of image data, such as image data output from the image reader 202 and various types of data other than the image data as appropriate in accordance with control by the CPU.

The external storage medium connector 216 has a connection port through which the external storage medium such as a USB memory can be connected and transmits/receives data such as various files to/from the external storage medium. Therefore, it is possible to take in data such as various files recorded in the external storage medium to the multifunction machine 20 side or to send data such as various files from the multifunction machine 20 side to the external storage medium for storage, for example.

The display unit 218 has a display 218a as a display. This display 218a works together with a touch panel 220a of the operation acceptor 220 and constitutes a display with touch panel (touch screen). This display 218a is a liquid crystal display (LCD), for example, but not limited to that, it may also be an organic EL display or the like. Moreover, the display unit 218 may include, in addition to the display 218a, an appropriate light emitting element such as a light emitting diode.

The operation acceptor 220 has the touch panel 220a as the operation receiver. This touch panel 220a works together with the display 218a as described above and constitutes a display with touch panel. Thus, the touch panel 220a is provided so that it overlaps a display surface of the display 218a. Moreover, the operation acceptor 220 may include an appropriate hardware switch such as a push button switch in addition to the touch panel 220a.

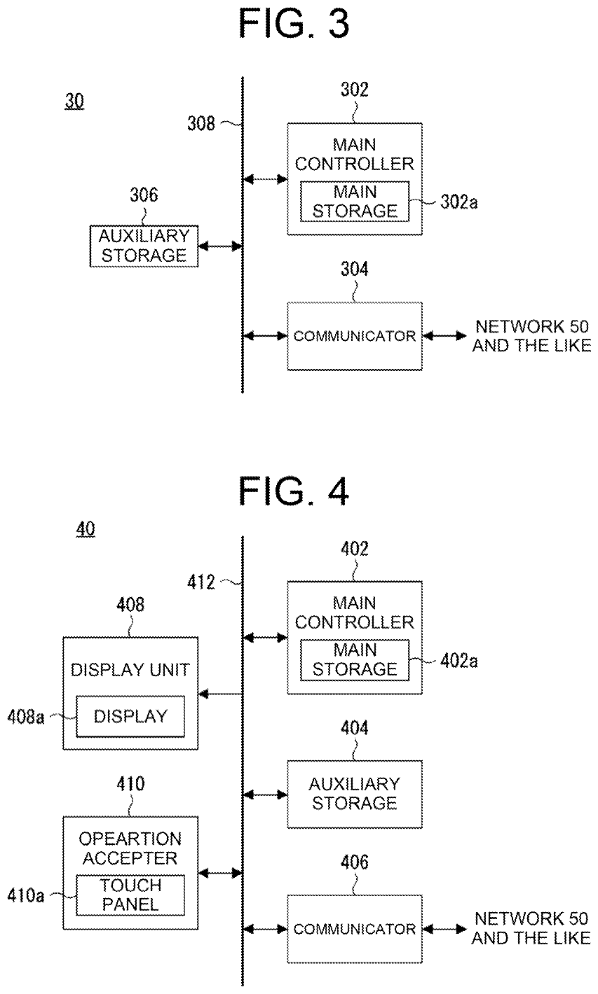

The server 30 in the first embodiment, as shown in FIG. 3, has a main controller 302, a communicator 304, and an auxiliary storage 306. These are connected to each other via a common bus 308.

The main controller 302 is a controller in the server 30 that takes charge of the overall control of the server 30. Thus, the main controller 302 includes a computer with a CPU. Moreover, the main controller 302 includes a main storage 302a as a main storage in the server 30. This main storage 302a includes a RAM and a ROM, for example.

The communicator 304 is a communicator in the server 30 that can perform bi-directional communication processing via the network 50.

The auxiliary storage 306 is an auxiliary storage in the server 30, including, for example, a hard disk and a flash memory.

The user terminal 40 in the first embodiment is a smartphone, a tablet computer, a personal computer or the like as described above and in the case of a smartphone, for example, it has a main controller 402, an auxiliary storage 404, and a communicator 406, as shown in FIG. 4. The smartphone as a user terminal 40 has a display unit 408 and an operation acceptor 410. These are connected to each other via a common bus 412.

The main controller 402 is a controller in the user terminal 40 that takes charge of the overall control of the user terminal 40. Thus, the main controller 402 includes a computer with a CPU. The main controller 402 also includes a main storage 402a as a main storage in the user terminal 40. This main storage 402a includes a RAM and a ROM, for example.

The communicator 406 of the user terminal 40 is a communicator in the user terminal 40 that executes bi-directional communication processing via the network 50. This communicator 406 can execute communication processing using a wireless method such as Wi-Fi and can also execute communication processing using a wired method. In addition, the communicator 406 can execute communication processing by the wireless method with the multifunction machine 20 (communicator 208).

The display unit 408 has a display 408a as a display in the user terminal 40. This display 408a works together with a touch panel 410a of the operation acceptor 410 and constitutes a display with touch panel. This display 408a is a liquid crystal display, for example, but not limited to that, and it may also be an organic EL display or the like.

The operation acceptor 410 has the touch panel 410a as the operation receiver in the user terminal 40. This touch panel 410a works together with the display 408a as described above and constitutes a display with touch panel. Thus, the touch panel 410a is provided so that it overlaps a display surface of the display 408a.

In the information processing system 10 of the first embodiment, upon reception of an event delivery request from the multifunction machine 20, the server 30 transmits that event information to both the multifunction machine 20 and the user terminal 40. The server 30 will then process a notification of the event in accordance with presence or absence of read information from the user terminal 40. In other words, the server 30 executes processing related to an event notification (or display processing) on the basis of whether it has been read or unread on the user terminal 40.

There are two types of such events, as will be described below.

Type 1 events are mere notifications and do not require cancellation of notification factors on the multifunction machine 20. In other words, an event notification of Type 1 is an event that only needs to be confirmed once by either the multifunction machine 20 or the user terminal 40, and does not need to be cancelled on the multifunction machine 20.

Events of this Type 1 include, for example, internal business notifications, notifications from an administrative department, notifications from the administrative department about revision of document formats, and announcements of new products and services from multifunction machine dealers. Such Type 1 event notifications should basically be delivered to the user terminals of all users, and do not need to be continuously displayed on the multifunction machine 20 after being confirmed (read) on the user terminal 40.

Type 2 events are event notifications that occurred at the multifunction machine 20 and whose notification factors need to be cancelled or confirmed on the multifunction machine 20. Therefore, an event of this Type 2 is an event in which, even if the relevant event notification has been confirmed (read) on the user terminal 40, it needs to be displayed on the multifunction machine 20 until the notification factor is cancelled or confirmed on the multifunction machine 20.

Events of this Type 2 include, for example, reception of print data, reception of facsimile data, contact on run-out of paper/toner, contact on firm-up (firmware update), printing of print data and the like.

There are two types of such Type 2 event notifications, that is, one that should be delivered only to the user terminal of a specific user, and the other that should be delivered to the user terminals of all users. For example, the notification of print data reception should be delivered to the specific user who sent the print data to the multifunction machine 20, the contact on the firmware upgrade should be delivered to the user terminals of all users belonging to a specific group, and facsimile data reception and out-of-paper/toner notifications should be delivered to the user terminals of all users.

In the events of Type 2, reception of facsimile data, contact on the firmware update and the like are displayed until they are confirmed once on the multifunction machine 20 or the notification factor is cancelled, for example. Notifications of out-of-paper/toner need to be displayed on the multifunction machine 20 until the notification factor is cancelled in the multifunction machine 20, even if it is confirmed (read) on the user terminal 40.

In the events of Type 2, printing of the print data and the like are events that require the cancellation of the notification factors on the multifunction machine 20, but that need cancellation of the notification factor by a specific user (target user).

In the multifunction machine 20, a program to process the events as described above is set.

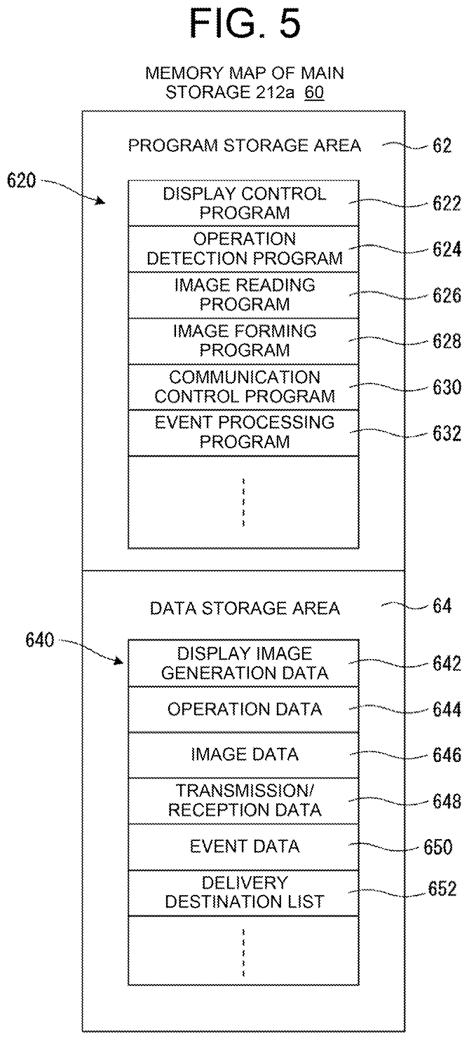

FIG. 5 shows a memory map 60 of the main storage 212a of the multifunction machine 20, and as shown in this memory map 60, the main storage 212a has a program storage area 62 and a data storage area 64.

The program storage area 62 stores a control program 620 for controlling the operation of the computer described above. This control program 620 includes a display control program 622, an operation detection program 624, an image reading program 626, an image forming program 628, a communication control program 630, an event processing program 632 and the like.

The display control program 622 is a program for generating display screen data required to display various screens on the display 218a of the display unit 218 (FIG. 2). The operation detection program 624 is a program for detecting an operation state by the user on the operation acceptor 220 including the touch panel 220a. The image reading program 626 is a program for controlling the image reader 202. The image forming program 628 is a program for controlling the image former 204. The communication control program 630 is a program for controlling the communicator 208.

Then, the event processing program 632 is a program that causes the main controller (computer) 212 to detect events as described above, to send an event delivery request to the server 30, to receive an event notification sent from the server 30, and to receive read information from the user terminal 40 sent from the server 30.

For example, an event of out-of-paper in the paper feeder can be detected in response to an out-of-paper signal from a paper sensor, which is input from the I/O interface 210. Similarly, an event of out-of-toner can be detected in response to an out-of-toner signal input from the toner sensor provided in the image former 204.

For example, the computer identifies the data (including a data identifier) received from the communicator 208 and can detect an event of receiving an internal notification, an event of receiving facsimile data, an event of receiving print data and the like. In addition, the computer can identify the data (including the data identifier) received from the communicator 208 and can detect an event of firmware update, an event of revision of the document format and the like.

For example, an event that the facsimile data was printed can be detected in response to an operation instructed by the computer to the image former 204. Similarly, an event that hold print data was printed can be detected in response to an operation instructed by the computer to the image former 204.

In the data storage area 64 shown in FIG. 5, a storage area 640 for various types of data is provided. Display image generation data, operation data, image data, transmission/reception data, event data, delivery destination lists and the like falls under the various types of data, and storage areas 642, 644, 646, 648, 650, 652 and the like are formed, respectively.

The display image generation data stored in the display image generation data storage area 642 is data such as polygon data and texture data used to generate the display screen data described above. The operation data stored in the operation data storage area 644 is data representing an operation state by the user on the operation acceptor 220 including the touch panel 220a and time-series data representing a touch position (coordinates) by the user on the touch panel 220a, for example. The image data stored in the image data storage area 646 is image data such as image data output from the image reader 202 and image data offered for image forming processing by the image former 204. The image data stored in the image data storage area 646 may also include facsimile data and print data described above. The transmission/reception data stored in the transmission/reception data storage area 648 is data that is transmitted/received with the server 30, the user terminal 40 and the like.

The event data stored in the event data storage area 650 is, for example, the event data detected by the event processing program 632 above.

The delivery destination list stored in the delivery-destination list storage area 652 is a list indicating to which user terminal (and multifunction machine) the event notification should be delivered when the multifunction machine 20 delivers event data in response to an event delivery request from the server 30. This delivery destination list stores to which user terminal (and multifunction machine) the event is to be delivered for each of the event types described above.

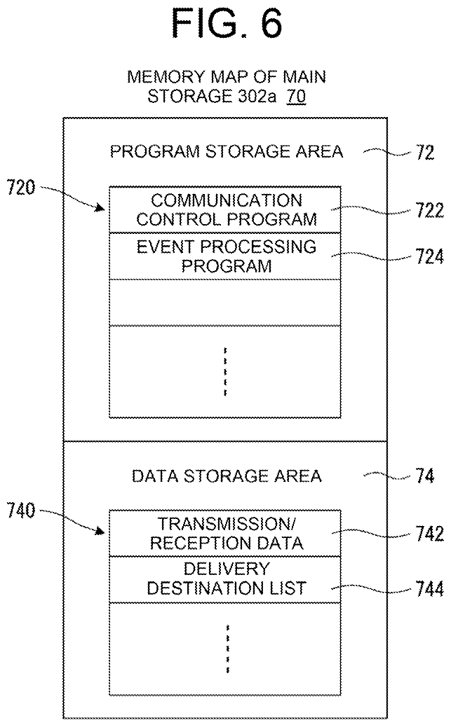

FIG. 6 shows the memory map 70 of the main storage 302a of the server 30. As shown in this memory map 70, the main storage 302a has a program storage area 72 and a data storage area 74.

In the program storage area 72, a control program 720 for controlling the operation of the computer of the main controller 302 is stored. This control program 720 includes a communication control program 722, an event processing program 724 and the like.

The communication control program 722 is a program for controlling the communicator 304. The event processing program 724 is a program that causes the main controller (computer) 302 to execute a store event processing which will be described later. However, the event processing here includes delivery (transmission) of an event notification to the user terminals 40 of the relevant users or all the users and the relevant multifunction machine 20 in response to an event delivery request from the multifunction machine 20 described above, re-delivery (re-transmission) of the event notification as necessary, reception of read information of the event notification from the user terminal 40 and transmission of the read information to the relevant multifunction machine 20 and the like.

On the other hand, in the data storage area 74, various data storage areas 740 are formed. The transmission/reception data stored in this various data storage areas 740 includes the transmission/reception data storage area 742 which stores the transmission/reception data such as the event data received from the multifunction machine 20, the delivery-destination list storage area 744 and the like. The delivery destination list is a list that indicates to which user terminal or multifunction machine the event notification should be delivered when this server 30 receives an event delivery request from the multifunction machine 20. This delivery destination list stores to which user terminal and multifunction machine the event should be delivered for each of the event types described above.

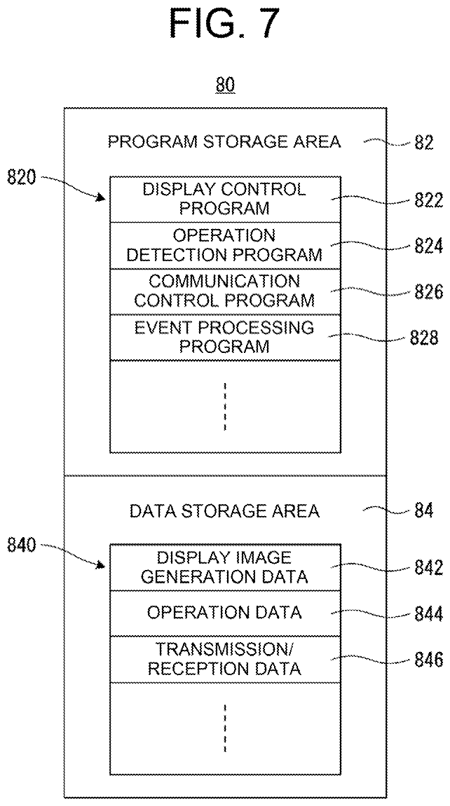

FIG. 7 shows a memory map 80 of the main storage 402a of the user terminal 40. The main storage 402a has a program storage area 82 and a data storage area 84. In the program storage area 82, a control program 820 for controlling the operation of the computer of the main controller 402 is stored. This control program 820 includes a display control program 822, an operation detection program 824, a communication control program 826, an event processing program 828 and the like.

The display control program 822 is a program for generating the display screen data required to display various screens on the display 408a of the display unit 408. The operation detection program 824 is a program for detecting the state of operation by the user on the operation acceptor 410 including the touch panel 410a. The communication control program 826 is a program for controlling the communicator 406. The event processing program 828 is a program that causes the main controller (computer) 402 to process the event notification data as described above.

In the data storage area 84, various data storages 840 are formed. A display image generation data storage area 842 stores the display image generation data such as polygon data and texture data used to generate the display screen data based on the display control program 822. The operation data stored in an operation data storage area 844 is data representing an operation state by the user on the operation acceptor 410 including the touch panel 410a and time-series data representing a touch position (coordinates) by the user on the touch panel 410a, for example. The transmission/reception data is then stored in a transmission/reception data storage area 846. The transmission/reception data includes the event data delivered from the server 30, the read information that is sent back to the server 30 when the user has read the event data on the user terminal 40 and the like.

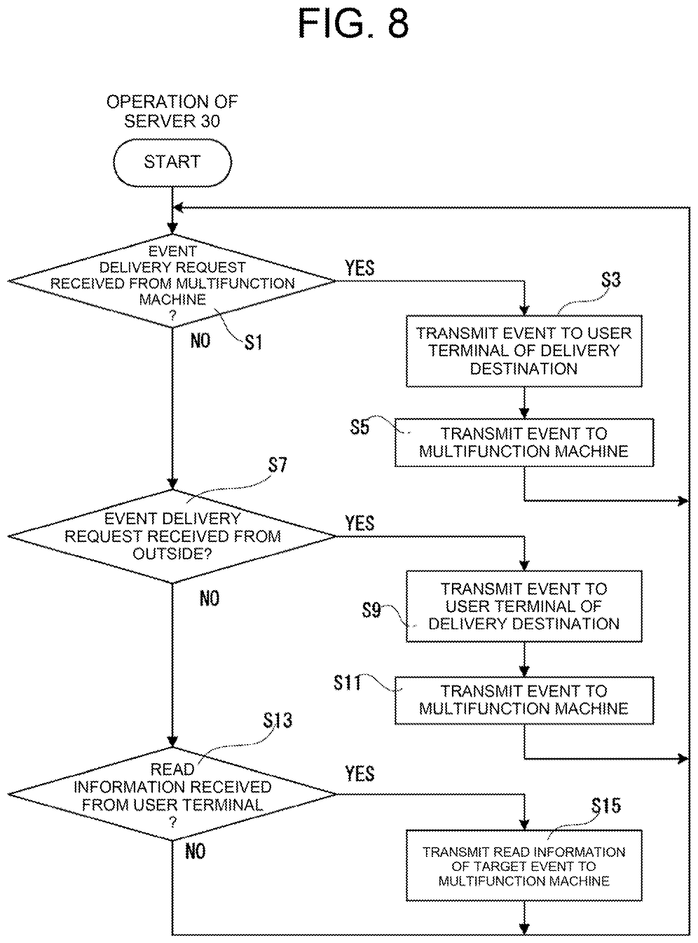

FIG. 8 is a flowchart showing the operation of the main controller 302 (computer) of the server 30 in this embodiment in accordance with the event processing program 724. This operation flow in FIG. 8 is assumed to be repeatedly executed for a predetermined time, that is, each frame cycle, for example.

At the first step S1, the main controller 302 determines whether or not an event delivery request has been received from the multifunction machine 20. At this step S1, the main controller 302 decodes the received data received from the communicator 304 (FIG. 3) in accordance with the event processing program 724 (FIG. 6) so as to determine whether or not the received data is a delivery request from the multifunction machine 20. The event delivery request from the multifunction machine 20 includes not only the event notification data to be delivered, but also data indicating which of Types 1 or 2 described above the event notification data corresponds to (type data). Therefore, the event notification data from the multifunction machine 20 is stored in the transmission/reception data storage area 742 (FIG. 6) along with the type data thereof.

When it is determined to be “YES” at step S1, the main controller 302 transmits the event, at step S3, whose the event notification data is stored in the transmission/reception data storage area 742 to the user terminal 40 of the delivery destination indicated by the delivery destination list according to the type. At the same time, at step S5, the main controller 302 transmits the event whose the event notification data is stored in the transmission/reception data storage area 742 to the multifunction machine 20 of the delivery destination indicated by the delivery destination list according to the type.

When it is determined to be “NO” at step S1, the main controller 302 determines, at the subsequent step S7, whether or not there is an event delivery request from outside. Here, the term “outside” means other computers (not shown), such as those connected via the network 50 (FIG. 1). For example, an event such as a request for advertisement from a sales company of the multifunction machine 20 falls under the event delivery request from the outside referred to here.

When it is determined to be “YES” at step S7, the main controller 302 stores the event data of such delivery request from the outside in the transmission/reception data storage area 742. Since such an event (advertisement, for example) from the event delivery request from the outside falls under Type 1, the type data indicating Type 1 is also stored in the transmission/reception data storage area 742.

Then, at steps S9 and S11, the event data is transmitted to the user terminal and the multifunction machine of the delivery destination indicated by the delivery destination list in accordance with the delivery request from the outside.

When it is determined to be “NO” at step S7, the main controller 302 determines, at step S13, whether or not the read information has been received from the user terminal 40 that delivered the event data at step S3 or S9. At this step S13, too, the main controller 302 can determine whether or not the received data is the read information from the user terminal 40 by referring to the received data received from the communicator 304 (FIG. 3) accordance with the event processing program 724 (FIG. 6).

When it is determined to be “YES” at step S13, the main controller 302 transmits, at the subsequent step S15, the read information to the multifunction machine 20 that received the event delivery request at step S1.

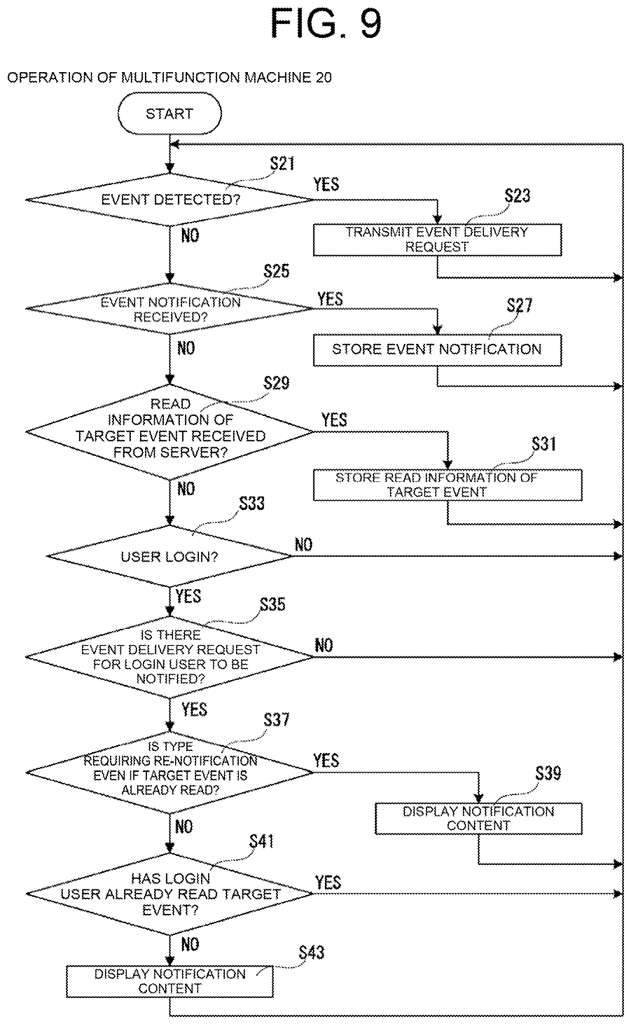

FIG. 9 is a flowchart showing the operation of the main controller 212 (computer) of the multifunction machine 20 in this embodiment in accordance with the event processing program 632. This operation flow in FIG. 9 is assumed to be repeatedly executed for a predetermined time, that is, each frame cycle, for example.

At the first step S21, the main controller 212 determines whether or not an event has been detected. When it is determined to be “YES” at this step S21, the main controller 212 transmits, at the subsequent step S23, an event delivery request with event notification data from the communicator 208 (FIG. 2) to the server 30 in accordance with the event processing program 632 (FIG. 5).

This event delivery request includes not only the event notification data to be delivered, but also data (type data) indicating to which of the two Types 1 and 2 described above, the event notification data corresponds. Then, at step S23, the event notification data contained in the event delivery request transmitted to the server 30 is stored in the transmission/reception data storage area 742 (FIG. 6) along with the type data.

When it is determined to be “NO” at step S21, the main controller 212 determines, at step S25, whether or not the event notification to the multifunction machine 20 has been received. The main controller 212 can determine whether or not the received data is event notification data from the server 30 by referring to the received data received from the communicator 208 (FIG. 2) in accordance with the event processing program 632 (FIG. 5).

When it is determined to be “NES” at this step S25, the main controller 212 stores, at step S27, the received event notification data (including the type data) in the transmission/reception data storage area 648. The main controller 212 that executes these steps S25 and S27 functions as an event notification receiver.

After storing the received event notification data at step S27 or after it is determined to be “NO” at step S25, the main controller 212 determines, at step S29, whether or not the read information of the target event (the event that the multifunction machine 20 requested the server 30 to deliver) at the user terminal has been received from the server 30. Again, the main controller 212 can determine whether or not the received data is the read information from the server 30 by referring to the received data received from the communicator 208 (FIG. 2) in accordance with the event processing program 632 (FIG. 5).

When it is determined to be “NES” at step S29, the read information of the target event is stored in the transmission/reception data storage area 648 at step S31. The main controller 212 that executes these steps S29 and S31 functions as a read information receiver.

When it is determined to be “NO” at step S29 or after step S31 has been executed, the main controller 212 determines, at step S33, whether or not a user has logged in the multifunction machine 20. Specifically, as is well known, a login screen GUI (Graphical User Interface), for example) is displayed on the display 218a, and the user is logged in after going through an authentication process by inputting the user ID and the like. However, when it is determined to be “NO” at this step S33, that is, if the user did not log in, the operation is finished.

When it is determined to be “YES” at step S33, the main controller 212 determines, at step S35, whether or not there is an event delivery request for that logged-in user to be notified. Here, the main controller 212 can determine that by referring to the event data and the delivery destination list stored in the event data storage area 650 and the delivery-destination list storage area 652 of the data storage area 64, respectively, in accordance with the event, processing program 632 (FIG. 5). The main controller 212 that executes this step S35 functions as an event notification receiver.

When it is determined to be “NO” at step S35, the operation is finished.

When it is determined to be “YES” at step S35, the main controller 212 determines, at step S37, whether or not the target event is an event that needs to be re-notified even if it has been read on the user terminal 40. Here, the main controller 212 can made determination by referring to the event data (including the type data) and the delivery destination list stored in the event data storage area 650 and the delivery-destination list storage area 652 of the data storage area 64, respectively.

When it is determined to the “YES” at step S37, the main controller 212 displays, at step S39, the event notification data (including the type data) stored in the transmission/reception data storage area 742 (FIG. 6) at step S23 on (the display 218a of) the display unit 218 in accordance with the display control program 622 (FIG. 6). In other words, step S39 is a step to re-display notification contents of the target event on the user terminal 40, even if reception of the read information from the user terminal 40 is definite, since the target event is the type of event that should be re-notified (displayed) on the multifunction machine 20, even if the user has confirmed it on the user terminal 40 (even if it has been read).

When it is determined to be “NO” at step S37, the main controller 212 determines, at the subsequent step S41, whether or not the user who logged in at step S33 has confirmed (read) the target event on the multifunction machine 20. Here, the main controller 212 can determine whether or not a confirmer displayed at the same time when the target event is displayed on the display 218a, such as an OK button, has been operated by the user, for example.

When it is determined to be “NES” at this step S41, since there is no need to re-notify (step S37, “NO”), the operation is finished as it is.

On the other hand, when it is determined to be “NO” at step S41, the main controller 212 displays, at step S43, the target event on the display 218a of the display unit 218 in accordance with the display control program 622.

In this way, different determinations are made at step S37 and step S41 depending on whether or not the read information from the user terminal 40 has been received, respectively, and step S39 is executed or not executed depending on the result. In other words, the main controller 212 that executes the steps S37 functions as an event processor that executes different processing regarding the event notification on the basis of whether or not the read information has been received.

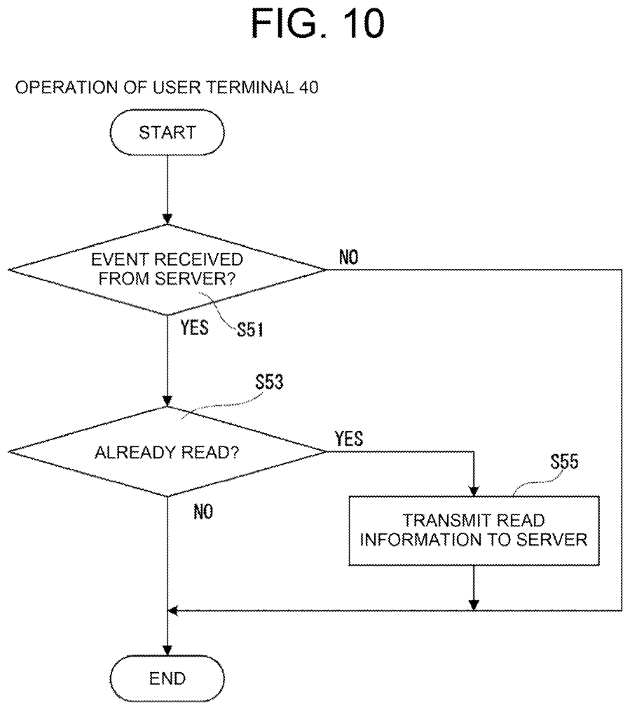

FIG. 10 is a flowchart showing the operation of the main controller 402 (computer) of the user terminal 40 in this embodiment in accordance with the event processing program 828. This operation flow in FIG. 10 is assumed to be repeatedly executed for a predetermined time, that is, each frame cycle, for example.

At the first step S51, the main controller 402 determines whether or not the event notification from the server 30 has been received. At this step S51, the main controller 402 can determine whether or not the received data received from the communicator 406 (FIG. 4) is the event notification delivered from the server 30. The received event data is displayed on the display 408a of the display unit 408 by the display control program 822 (FIG. 7).

When it is determined to be “NO” at step S51, the operation is finished. On the other hand, when it is determined to be “YES” at step S51, the main controller 402 determines whether or not the event notification has been confirmed (read) at step S53. Here, the main controller 402 can determine whether or not a confirmer displayed at the same time when the event is displayed on the display 408a, such as an OK button, has been operated by the user, for example.

When it is determined to be “NES” at step S53, the main controller 402 transmits the read information to the server 30. For example, in response to the operation of the confirmer described above, the main controller 402 controls the communication control program 822 (FIG. 7) so as to transmit the read information to the server 30 and finishes the operation.

When it is determined to be “NO” at step S53, that is, the event notification has not been read, the operation is finished.

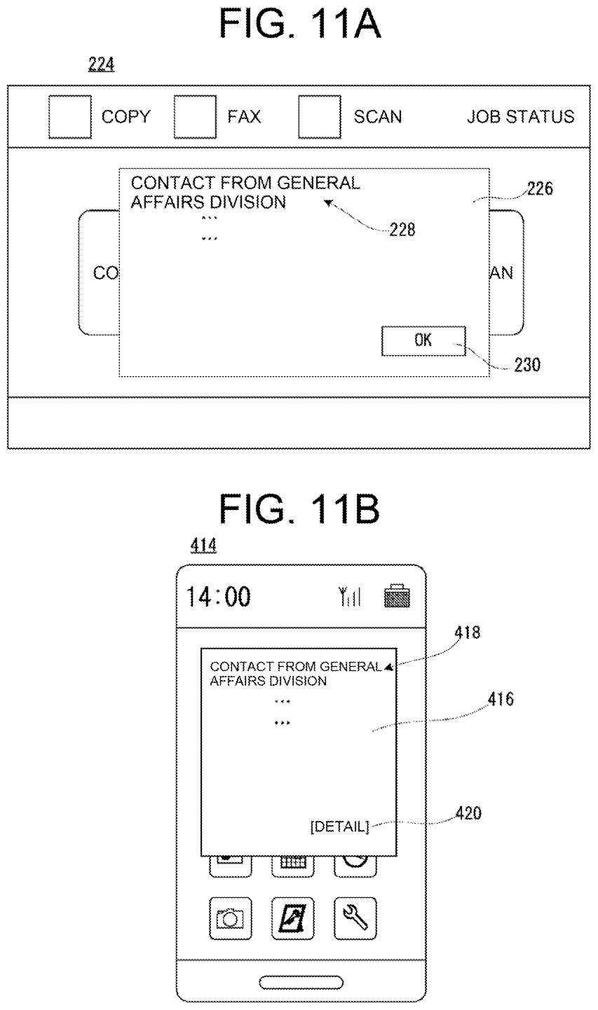

Subsequently, by referring to FIG. 11A and FIG. 11B to FIG. 14A and FIG. 14B, specific examples of different types of event notifications will be described.

FIG. 11A and FIG. 11B show a case where an event notification of Type 1 is transmitted from the server 30 to both the multifunction machine 20 and the user terminal 40, in which FIG. 11A shows an example of a display screen 224 of the display 218a of the multifunction machine 20, and FIG. 11B shows an example of a display screen 414 of the display 408a of user terminal 40. The event notification shown in FIG. 11A and FIG. 1.1B is an “internal business notification”, which belongs to Type 1 as explained earlier.

In the case of this example, the event notification for this internal business notification is input into the server 30 from an external computer or a server (not shown) through the communicator 304. This event notification data, together with the type data, is stored in the transmission/reception data storage area 742 (FIG. 6) of the main storage 302 of the server 30. Then, the main controller (computer) 302 of the server 30 refers to the type data and recognizes that the event notification at this time belongs to Type 1. Thus, the main controller 302 determines “YES” at step S7 in FIG. 8 and, at steps S9 and S11, transmits the event notification data (including the type data) to the user terminals 40 of all the users and to all the multifunction machines 20 in accordance with the delivery destination list for the event notification of Type 1 stored in the delivery-destination list storage area 744.

Therefore, the main controller (computer) 212 of the multifunction machine 20 stores the received event notification data along with the type data in the event data storage area 650 in accordance with the event processing program 632 (FIG. 5).

In the user terminal 40, too, the main controller (computer) 402 stores the received event notification data along with the type data in the transmission/reception data storage area 846, which also functions as the event data storage area, in accordance with the event processing program 828 (FIG. 7).

Then, the main controller (computer) 402 displays a pop-up 416 on the display screen 414 of the display 408a and displays an event notification 418 and a detail button 420 in the pop-up 416 in accordance with the display control program 822. This detail button 420 is a software button to be operated when the details of the event notification is to be confirmed (read) and is operated on the touch panel 410a.

When this detail button 420 is operated by the user, the main controller 402 determines that the event notification 418 has been confirmed by the user (FIG. 10: Step S53) and transmits the read information to the server 30.

This read information is transmitted from the server 30 to the multifunction machine 20 (FIG. 8: Step S13).

In response to this, the main controller 212 of the multifunction machine 20 determines “YES” at step S29 shown n FIG. 9 and stores this read information in the event data storage area 650 (FIG. 5).

The main controller 212 of the multifunction machine 20 determines, on the basis of the type data contained in the previously stored event data, that the current event notification belongs to Type 1 and that if it is confirmed (read) on the user terminal 40, there is no need to confirm it on the multifunction machine 20 (“NO” at step S37, “YES” at step S41) so the event notification is not displayed on the multifunction machine 20.

However, if there is no read information on the user terminal 40, it is determined to be “NO” at step S41 and thus, the main controller 212 displays a pop-up 226 on the display screen 224 of the display 218a and also displays an event notification 228 based on the event data stored in the event data storage area 650 and an OK button 230 in the pop-up 226 in accordance with the display control program 622. This OK button 230 is a software button to be operated when the event notification is confirmed (read) and is operated on the touch panel 220a.

Thus, in the case of an event belonging to Type 1, which is an event that does not require cancellation of the notification factor on the multifunction machine 20, if the event is confirmed (read) on the user terminal 40, it is not displayed again on the multifunction machine 20. However, events belonging to Type 1 are displayed on the multifunction machine 20 when there is no read information from the user terminal 40.

In the embodiment shown in FIG. 11A and FIG. 11B, the event notification delivered to the multifunction machine 20 and the event notification delivered to the user terminal 40 are identical, but they do not necessarily have to be identical and only need to be event notifications with the same purpose, which can also be considered to be the same event notification.

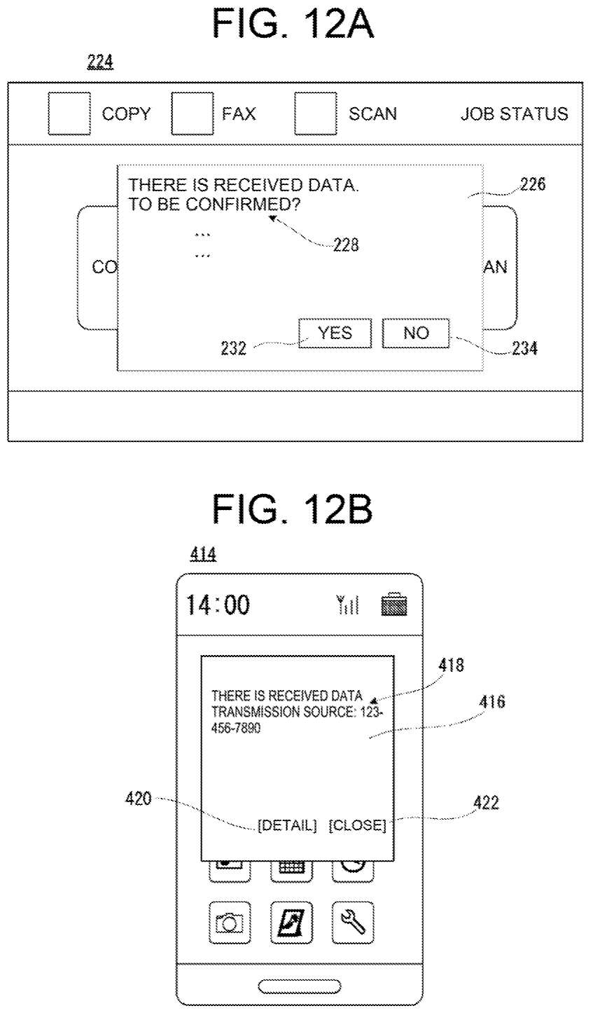

FIG. 12A and FIG. 12B show a case where an event belonging to Type 2 is delivered from the server 30 to both the multifunction machine 20 and the user terminal 40, in which FIG. 12A shows an example of the display screen 224 of the display 218a of the multifunction machine 20, while FIG. 12B shows an example of the display screen 414 of the display 408a of the user terminal 40. The event notification shown in FIG. 12A and FIG. 12B is “facsimile received”, which belongs to Type 2 described earlier.

This event notification of “facsimile received” is notified to all registered users because the server 30 cannot know in advance to whom the facsimile data is addressed, although only one person actually needs to be notified. Then, it is necessary not only that the notification content should be confirmed on the user terminal 40 (personal device), but also the multifunction machine 20 needs to be operated so that the notification factor is cancelled.

The facsimile data is input into the multifunction machine 20 from an external computer or a facsimile device (not shown) through the communicator 208 (FIG. 2). When the reception of the facsimile data is completed, the main controller (computer) 212 determines “YES” at step S21 in which it is determined whether or not an event has been detected. Then, at step S23, an event delivery request for delivery of the detected event is transmitted to the server 30. At this time, the data of the event notification of the reception of the facsimile data and the type data of the event notification data (in this case, Type 2) are transmitted to the server 30.

On the other hand, this event notification data, along with the type data, is stored in the transmission/reception data storage area 742 (FIG. 6) of the main storage 302 of the server 30. Then, the main controller (computer) 302 of the server 30 refers to the type data and recognizes that the event notification at this time belongs to Type 2. Thus, the main controller 302 determines “YES” at step S1 in FIG. 8 and, at steps S3 and S5, transmits the event notification data (including the type data) to the user terminals 40 of all the users and to all the multifunction machines 20 in accordance with the delivery destination list for the event notification of Type 2 stored in the delivery-destination list storage area 744.

Therefore, the main controller (computer) 212 of the multifunction machine 20 stores the received event notification data along with the type data in the event data storage area 650 in accordance with the event processing program 632 (FIG. 5).

In the user terminal 40, too, the main controller (computer) 402 stores the received event notification data along with the type data in the transmission/reception data storage area 846, which also functions as the event data storage area, in accordance with the event processing program 828 (FIG. 7).

Then, the main controller (computer) 402 displays the pop-up 416 on the display screen 414 of the display 408a and displays the event notification 418 with the contents that “There is received data. Sender: 123-456-7890”, the detail button 420, and a close button 422 in the pop-up 416 in accordance with the display control program 822. This detail button 420 is a software button to be operated when the details of the event notification is confirmed (read) and is operated on the touch panel 410a. This close button 422 is a software button to be operated when the event notification 418 is closed after confirming (reading) the details of the event notification and is and is operated on the touch panel 410a.

When this detail button 420 or close button 422 is operated by the user, the main controller 402 determines that the event notification 418 has been confirmed by the user (FIG. 10: Step S53) and transmits the read information to the server 30.

This read information is transmitted from the server 30 to the multifunction machine 20 (FIG. 8: Step S13).

In response to this, the main controller 212 of the multifunction machine 20 determines “YES” at step S29 shown in FIG. 9 and stores this read information in the event data storage area 650 (FIG. 5).

The main controller 212 of the multifunction machine 20 determines, on the basis of the type data contained in the previously stored event data, that the current event notification belongs to Type 2 and that it needs to be confirmed by the multifunction machine 20 even if it is confirmed (read) by the user terminal 40 (“YES” at step S37), so the main controller 212 displays, at step S39, the event notification data (including the type data) stored in the transmission/reception data storage area 742 (FIG. 6) at step S23 and displays the pop-up 226 containing the event notification 228 and a Yes button 232 and a No button 234 on the display screen 224 of the display 218a in accordance with the display control program 622 (FIG. 6). The Yes button 232 and the No button 234 are software buttons to respond to the content of the event notification 228 at this time that “There is received data. To be confirmed?” and are operated on the touch panel 220a.

As shown above, in the case of an event belonging to Type 2, it is necessary not only that the notification content should be confirmed on the user terminal 40 as a personal device, but also that the multifunction machine 20 should be operated to cancel the event notification factor and thus, the event content is displayed at step S39 regardless of presence/absence of the read information on the user terminal 40.

In the embodiment shown in FIG. 12A and FIG. 12B, the event notification delivered to the multifunction machine 20 and the event notification delivered to the user terminal 40 are not identical, but they are event notifications with the similar purpose and thus, they can be considered to be the same event notification.

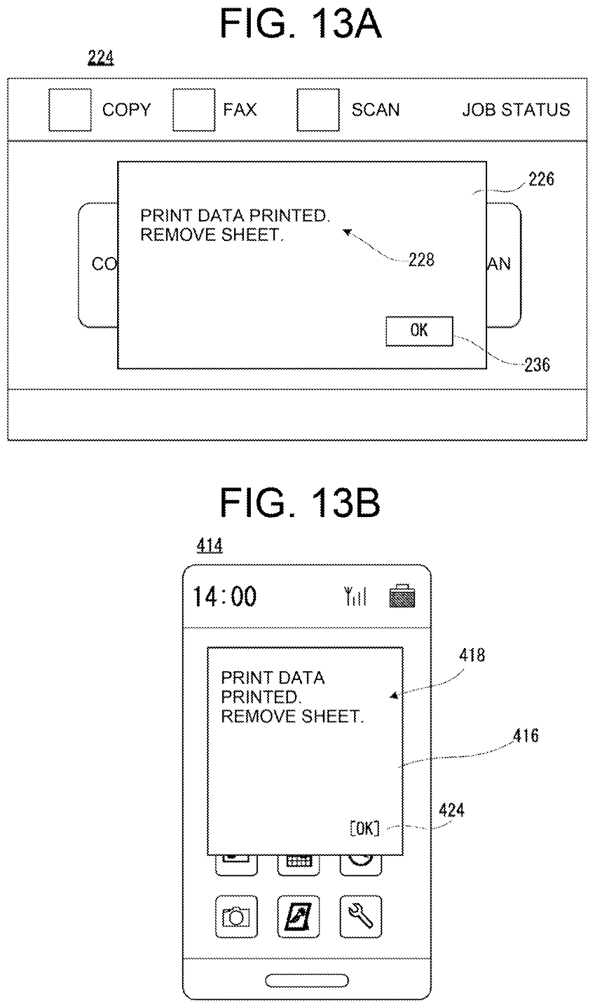

FIG. 13A and FIG. 13B show a case where an event belonging to Type 2 is delivered from the server 30 to both the multifunction machine 20 and the user terminal 40, in which FIG. 13A shows an example of the display screen 224 of the display 218a of the multifunction machine 20, while FIG. 13B shows an example of the display screen 414 of the display 408a of the user terminal 40. The event notification shown in FIG. 13A and FIG. 13B is a “sheet removal notification after print data printing”, which belongs to Type 2 described earlier.

The notification target of this “sheet removal notification after print data printing” event can only be a specific target user who transmitted the print data, and it is necessary not only that the contents of the notification should be confirmed on the user terminal 40 (personal device), but also that the notification should be cancelled by the target user by operating the multifunction machine 20.

When printing of the print data is completed, the main controller (computer) 212 determines “YES” at step S21 in which it is determined whether or not an event has been detected. Then, at step S23, an event delivery request for delivery of the detected event is transmitted to the server 30. At this time, the data of the event of the “sheet removal notification after print data printing” and the type data of the event notification data (in this case, Type 2) are transmitted to the server 30. However, the event notification data at this time includes user information that can identify the user who transmitted the print data.

On the other hand, this event notification data, along with the type data, is stored in the transmission/reception data storage area 742 (FIG. 6) of the main storage 302 of the server 30. Then, the main controller (computer) 302 of the server 30 refers to the type data and recognizes that the event notification at this time belongs to Type 2. Thus, the main controller 302 determines “YES” at step S1 in FIG. 8 and, at steps S3 and S5, transmits the event notification data (including the type data) to the user terminal 40 of the user indicated by the user information contained in the event notification data and to the multifunction machine 20 in accordance with the delivery destination list for the event notification of Type 2 stored in the delivery-destination list storage area 744.

Therefore, the main controller (computer) 212 of the multifunction machine 20 stores the received event notification data, along with the type data, in the event data storage area 650 in accordance with the event processing program 632 (FIG. 5).

In the user terminal 40 of the user indicated by the user information above, too, the main controller (computer) 402 stores the received event notification data, along with the type data, in the transmission/reception data storage area 846, which also functions as the event data storage area, in accordance with the event processing program 828 (FIG. 7).

Then, the main controller (computer) 402 displays the pop-up 416 on the display screen 414 of the display 408a and displays the event notification 418 with the content that “Print data printed. Remove sheet.” and an OK button 424 in the pop-up 416 in accordance with the display control program 822. This OK button 424 is a software button to be operated when the content of the event notification has been confirmed (read) and is operated on the touch panel 410a.

When this OK button 424 is operated by the user, the main controller 402 determines that the event notification 418 has been confirmed by the user (FIG. 10: Step S53) and transmits the read information to the server 30.

This read information is transmitted from the server 30 to the multifunction machine 20 (FIG. 8: Step S13).

In response to this, the main controller 212 of the multifunction machine 20 determines “YES” at step S29 shown in FIG. 9 and stores this read information in the event data storage area 650 (FIG. 5).

The main controller 212 of the multifunction machine 20 determines, on the basis of the type data contained in the previously stored event data, that the current event notification belongs to Type 2 and that it needs to be confirmed on the multifunction machine 20 even if it is confirmed (read) on the user terminal 40 (“YES” at step S37), so the main controller 212 displays, at step S39, the event notification data (including the type data) stored in the transmission/reception data storage area 742 (FIG. 6) at step S23 and displays the pop-up 226 containing the event notification 228 and an OK button 236 on the display screen 224 of the display 218a in accordance with the display control program 622 (FIG. 6). The OK button 236 is a software button to be operated when the paper is removed after confirming the content of the event notification 228 at this time that “Print data printed. Remove sheet.” and is operated on the touch panel 220a.

In this case, too, it is necessary not only that the notification content should be confirmed on the user terminal 40 as a personal device, but also that the multifunction machine 20 should be operated to cancel the event notification factor and thus, the event content is displayed at step S39 regardless of presence/absence of the read information on the user terminal 40.

In the embodiment shown in FIG. 13A and FIG. 13B, the event notification delivered to the multifunction machine 20 and the event notification delivered to the user terminal 40 are identical, but they do not necessarily have to be identical and only need to be event notifications with the similar purpose, which can also be considered to be the same event notification.

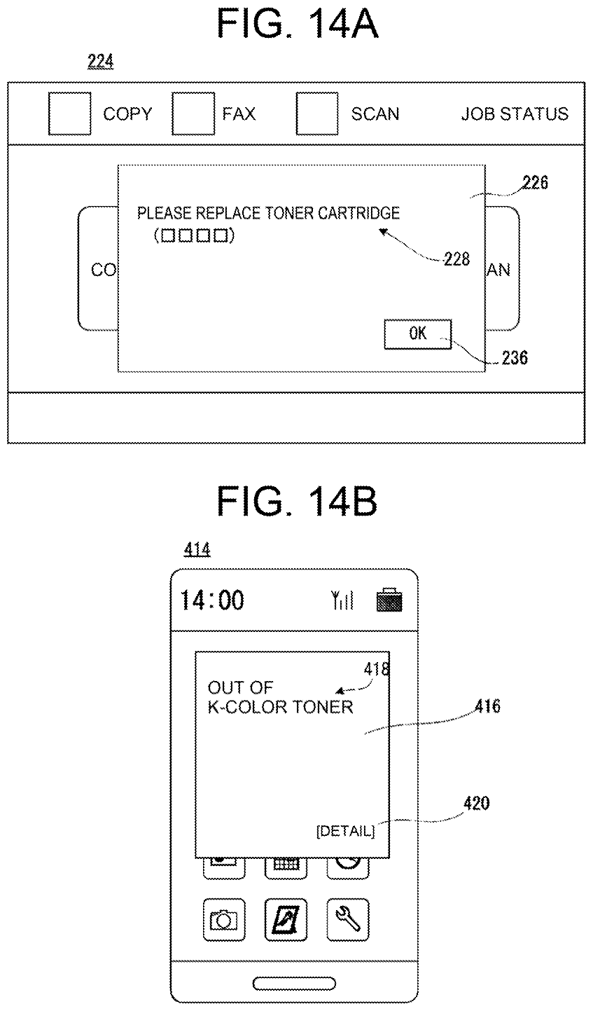

FIG. 14A and FIG. 14B show a case where an event belonging to Type 2 is delivered from the server 30 to both the multifunction machine 20 and the user terminal 40, in which FIG. 14A shows an example of the display screen 224 of the display 218a of the multifunction machine 20, while FIG. 14B shows an example of the display screen 414 of the display 408a of the user terminal 40. The event notification shown in FIG. 14A and FIG. 14B is an “out-of-toner notification”, which belongs to Type 2.

The notification targets of this “out of toner notification” event are all including general users but the notification factor is cancelled by an administrator of the multifunction machine 20. Therefore, the general users only need to make confirmation on either of the user terminal (personal device) 40 and the multifunction machine 20, but the administrator needs not only to notify the user terminal 40 but also to cancel the notification factor by operating the multifunction machine 20.

When the out-of-toner signal from the toner sensor (not shown) is input into the main controller (computer) 212 via the I/O interface 210, it is determined to be “YES” at step S21 in which it is determined whether or not an event has been detected. Then, at step S23, an event delivery request for delivery of the detected event is transmitted to the server 30. At this time, the data of the event of the “out-of-toner notification” and the type data of the event notification data (in this case, Type 2) are transmitted to the server 30.

On the other hand, this event notification data, along with the type data, is stored in the transmission/reception data storage area 742 (FIG. 6) of the main storage 302 of the server 30. Then, the main controller (computer) 302 of the server 30 refers to the type data and recognizes that the event notification at this time belongs to Type 2. Thus, the main controller 302 determines “YES” at step S1 in FIG. 8 and, at steps S3 and S5, transmits the event notification data (including the type data) to the user terminals 40 of all the users and to all the multifunction machines 20 in accordance with the delivery destination list for the event notification of Type 2 stored in the delivery-destination list storage area 744.

Therefore, the main controller (computer) 212 of the multifunction machine 20 stores the received event notification data, along with the type data, in the event data storage area 650 in accordance with the event processing program 632 (FIG. 5).

In the user terminal 40 of the user indicated by the user information above, too, the main controller (computer) 402 stores the received event notification data, along with the type data, in the transmission/reception data storage area 846, which also functions as the event data storage area, in accordance with the event processing program 828 (FIG. 7).

Then, the main controller (computer) 402 displays the pop-up 416 on the display screen 414 of the display 408a and displays the event notification 418 with the content that “Out of K-color toner” and the detail button 420 in the pop-up 416 in accordance with the display control program 822. This detail button 420 is a software button to be operated when the details of the event notification is confirmed (read) and is operated on the touch panel 410a.

When this detail button 420 is operated by the user, the main controller 402 determines that the event notification 418 has been confirmed by the user (FIG. 10: Step S53) and transmits the read information to the server 30.

This read information is transmitted from the server 30 to the multifunction machine 20 (FIG. 8: Step S13).

In response, the main controller 212 of the multifunction machine 20 determines “YES” at step S29 shown in FIG. 9 and stores this read information in the event data storage area 650 (FIG. 5).

The main controller 212 of the multifunction machine 20 determines, on the basis of the type data contained in the previously stored event data, that the current event notification belongs to Type 2 and that it needs to be confirmed on the multifunction machine 20 even if it is confirmed (read) on the user terminal 40 (“YES” at step S37), so the main controller 212 displays, at step S39, the event notification data (including the type data) stored in the transmission-reception data storage area 742 (FIG. 6) at step S23 and displays the pop-up 226 containing the event notification 228 and the OK button 236 on the display screen 224 of the display 218a in accordance with the display control program 622 (FIG. 6), The OK button 236 is a software button to be operated when the content of the event notification 228 at this time that “Please replace toner cartridge. (□□□□)” is confirmed and the toner cartridge is replaced and is operated on the touch panel 220a.

In this case, too, it is necessary not only that the notification content should be confirmed on the user terminal 40 as a personal device, but also that the multifunction machine 20 should be operated to cancel the event notification factor and thus, the event content is displayed at step S39 regardless of presence/absence of the read information on the user terminal 40.

In the embodiment shown in FIG. 14A and FIG. 14B, the event notification delivered to the multifunction machine 20 and the event notification delivered to the user terminal 40 are not identical, but they are event notifications with the similar purpose and thus, they can be considered to be the same event notification.

In the above embodiment, the server 30 is provided to deliver event notifications, but the function of the server 30 can be provided on the multifunction machine 20, and the server 30 can be omitted. In this case, the flowchart in FIG. 8 can be incorporated in the event processing program 632 (FIG. 5) of the multifunction machine 20 so that the main controller (computer) 212 of the multifunction machine 20 can take over the operation of the main controller (computer) 302 of the server 30.

What is claimed is:

1. An information processing apparatus, comprising:
an event notification receiver that receives the same event notification as for a user terminal;
a read information receiver that receives read information indicating that the user terminal has confirmed the event notification; and
an event processor that executes different processing regarding the event notification on the basis of whether or not the read information was received by the read information receiver.

2. The information processing apparatus according to claim 1, further comprising:
a display unit, wherein
the event processor executes different processing in the display unit of the event notification.

3. The information processing apparatus according to claim 2, wherein
the event notification includes a first event notification and a second event notification of a type different from that of the first event notification; and
in a case where the event notification received by the event notification receiver is the first event notification, the event processor does not display the first event notification on the display unit when the read information receiver receives the read information.

4. The information processing apparatus according to claim 3, wherein,
in a case where the event notification received by the event notification receiver is the second event notification, even if the read information receiver has received the read information, the event processor displays the second event notification on the display unit.

5. An information processing method in an information processing apparatus, comprising:
event notification receiving to receive the same event notification as for a user terminal;
read information receiving to receive read information indicating that the user terminal has confirmed the event notification; and
event processing to execute different processing regarding the event notification on the basis of whether or not the read information has been received in the read information receiving.
